(19) United States
(12) Patent Application Publication
(10) Pub. No.: US 2008/0298085 A1
(43) Pub. Date: Dec. 4, 2008

(54) Backlight module with uniform brightness

(76) Inventor: Sheng-Hui Chiang, Taichung (TW)

Correspondence Address: COOPER & DUNHAM, LLP, 1185 AVENUE OF THE AMERICAS, NEW YORK, NY, 10036, US

(21) Appl. No.: 11/809,632

(22) Filed: May 31, 2007

(51) Int. Cl. F21V 8/00; F21V 7/00

(52) U.S. Cl. 362/612; 362/614; 362/625

(57) ABSTRACT

A backlight module with uniform brightness has a light guide panel (LGP), a diffusing reflector, at least one light source and a diffuser and a prism film. The diffusing reflector is placed on the LGP and has a substrate, a reflective film and multiple diffusing elements. The reflective film is formed on the substrate. Each one of the multiple diffusing elements has an adhesive bed and multiple balls. The multiple balls can be easily pasted or printed separately on the reflective film by using the adhesive bed and provide a uniform diffused light output form the LGP, so the backlight module has a lowered cost and is easily manufactured.

### BACKGROUND OF THE INVENTION

1. Field of Invention

The present invention relates to backlight module, and more particularly to a backlight module with uniform brightness for liquid crystal display panel.

2. Description of the Related Art

Thin Film Transistor Liquid Crystal Display (TFTLCD) is widely used in cell phones, televisions and a many such like electronic devices. With reference to FIG. 4, each TFTLCD contains a backlight module (90) and a Liquid Crystal (LC) module (60). The backlight module (90) is placed at a rear surface of the LC module (60) and provides a surface light source for the LC module. The backlight module (90) may be laminated with prism film (95), a diffusing film (94), a light guide panel (LGP) (91), a reflective film (92), and further comprises at least one light source (93) being placed at two edges of the LGP (91). The LGP (91) has a rear surface and a front surface. In a conventional backlight module, the rear surface of the LGP (91) comprises multiple diffusing elements. Each of the multiple diffusing elements may be formed by a reflective ink on or etched into the surface, and is used to diffuse light transmitted from the light source (93) and transmit the light to an output light on the front surface. However, processes for producing the multiple diffusing elements on the rear surface of the LGP (91) is difficult and expensive.

To overcome the shortcomings, the present invention provides a backlight module with uniform brightness to mitigate or obviate the aforementioned problems of the conventional backlight module.

### SUMMARY OF THE INVENTION

The objective of the present invention is to provide a backlight module with uniform brightness that is simply produced and is low cost.

The backlight module with uniform brightness in accordance with the present invention comprises a light guide panel (LGP), a diffusing reflector, at least one light source and optional diffuser and an optional prism film. The diffusing reflector is placed on the LGP and has a substrate, a reflective film and multiple diffusing elements. The reflective film is formed on the substrate. Each one of the multiple diffusing elements has an adhesive bed and multiple balls. The multiple balls can be easily bonded or printed separately on the reflective film and provide a uniform diffused light output form the LGP which is cheaper and easier to manufacture than producing diffusing elements on the rear surface of the LGP.

Other objectives, advantages and novel features of the invention will become more apparent from the following detailed description when taken in conjunction with the accompanying drawings.

### BRIEF DESCRIPTION OF THE DRAWINGS

FIG. 1 is a cross-sectional side view of a backlight module with uniform brightness applied for a Thin Film Transistor Liquid Crystal Display (TFTLCD) in accordance with the present invention;

FIG. 2 is a perspective view of a diffusing reflector of the backlight module with uniform brightness in FIG. 1;

FIG. 3 is an enlarged cross-sectional side view of the diffusing reflector of backlight module with uniform brightness; and

FIG. 4 is a cross-sectional side view of a TFTLCD with a conventional backlight module.

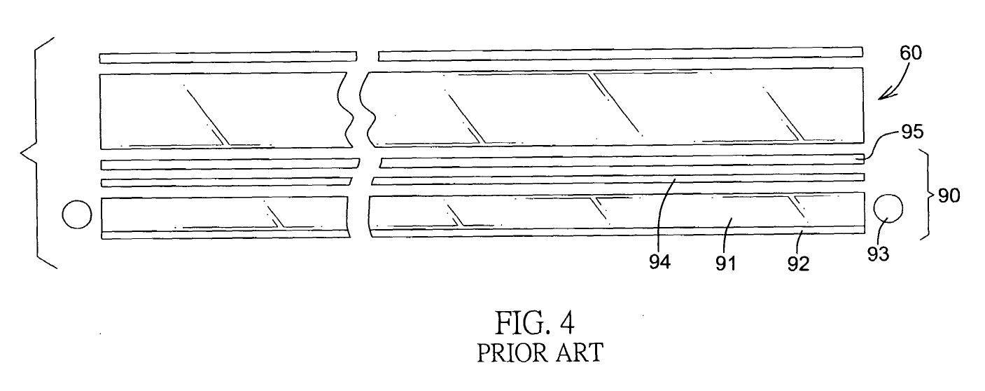

### DETAILED DESCRIPTION OF THE INVENTION

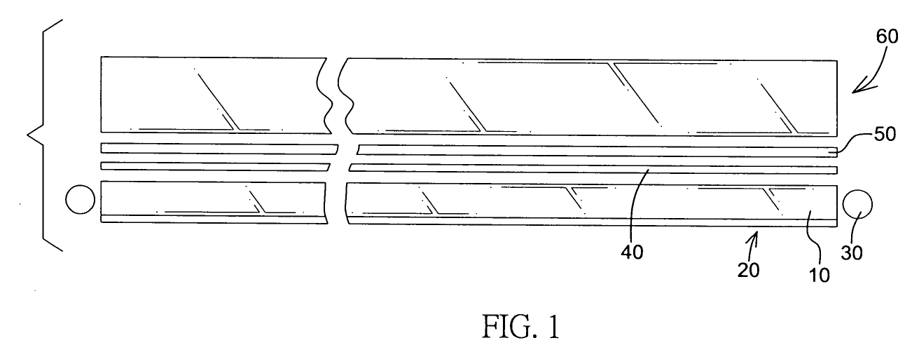

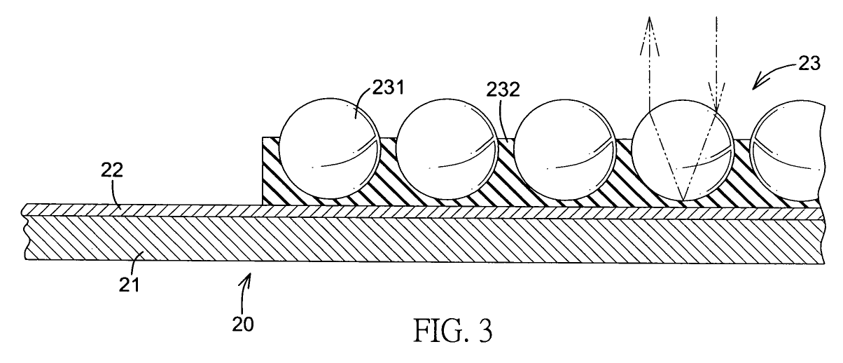

With reference to FIGS. 1, 2, and 3, a backlight module with uniform brightness comprises a light guide panel (LGP) (10), a diffusing reflector (20), at least one light source (30), an optional diffuser (40) and an optional prism film (50).

The LGP (10) may be a transparent sheet, is used for guiding light, may be acrylic and has a top surface, a bottom surface and two edges.

The diffusing reflector (20) is formed on the bottom surface of the LGP (10), and has a substrate (21), a reflective film (22) and multiple diffusing elements (23).

The substrate (21) may be flexible, and has a top surface and a bottom surface. The reflective film (22) strongly reflects visible light, is formed on the top surface of the substrate (21) and has a top surface.

The multiple diffusing elements (23) are distributed on the top surface of the reflective film (22) and have a coverage density. The coverage density is defined as a percentage of the area of the reflective film (22) covered by the multiple diffusing elements (23). Each one of the multiple diffusing elements (23) may be formed as a spot or a strip, is printed or adhered at a specific location on the top surface of the reflective film (22) and. has multiple balls (231) and an adhesive bed (232). The multiple balls (231) may be translucent or transparent, are adhered in the adhesive bed (232) and reflect light from the bottom surface of the LGP (10). The adhesive bed (232) of each diffusing element (23) is formed on the top surface of the reflective film (22) and has a bottom surface.

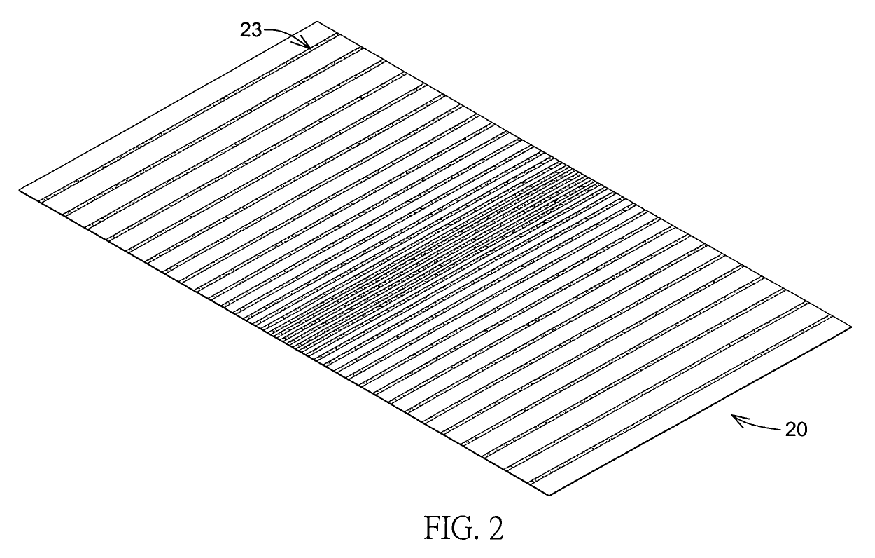

With further reference to FIG. 2, in a first embodiment of the present invention, each one of the multiple diffusing elements (23) is formed as a strip and is pasted parallel to the edge of the LGP (10) on the top surface of the reflective film (23) at a distance from the light source.

Each light source (30) may be a light tube such as a cold cathode fluorescent lamps (CCFL) or multiple aligned Light Emitting Diodes, placed in parallel to the edge of the LGP (10) and provides light to the LGP (10). The coverage density of the first embodiment of the present invention is not uniform, but is gradually changed in relation to the distance from the light source (30). Therefore, the coverage density of the multiple diffusing elements (23) near the light source (30) is lower than the coverage density far from the light source (30).

The diffuser (40) is a transparent sheet, is positioned on the top surface of the LGP (10), diffuses light transmitted form the top surface of the LGP (10) and has a top surface.

The prism film (50) is transparent, is placed on the top surface of the diffuser (40) and focuses the diffused light transmitted from the top surface of the diffuser (40) or LGP.

The backlight module with uniform brightness as described has a simple structure that is easily fabricated, cheaper than previous methods and provides an uniform light output for a liquid crystal cell (60).

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A backlight module with uniform brightness comprising
a light guide panel (LGP) being a transparent sheet and having
a top surface;
a bottom surface; and
two edges;
a diffusing reflector being formed on the bottom surface of the LGP and having
a substrate having
a top surface; and
a bottom surface;
a reflective film being reflective, being formed on the top surface of the substrate and having a top surface; and
multiple diffusing elements being distributed on the top surface of the reflective film and having
multiple balls being translucent; and
an adhesive bed being formed on the top surface of the reflective film and adhered to the multiple balls; and
at least one light source being placed beside the edge of the LGP and providing light to the LGP.

2. The backlight module with uniform brightness as claimed in claim 1, wherein the substrate is flexible.

3. The backlight module with uniform brightness as claimed in claim 1, wherein the light source is a cold cathode fluorescent lamps.

4. The backlight module with uniform brightness as claimed in claim 1, wherein the light source is multiple aligned Light Emitting Diodes.

5. The backlight module with uniform brightness as claimed in claim 1, wherein the light source is placed parallel to the edge of the LGP.

6. The backlight module with uniform brightness as claimed in claim 1, wherein the reflective film has a variable coverage density.

7. The backlight module with uniform brightness as claimed in claim 1, wherein the coverage density near the light source of the top surface of the reflective film is lower than the coverage density far from the light source.

8. The backlight module with uniform brightness as claimed in claim 1, wherein the backlight module with uniform brightness has an optical diffuser being a transparent sheet, being positioned on the top surface of the LGP and having a top surface.

9. The backlight module with uniform brightness as claimed in claim 1, wherein the backlight module with uniform brightness has a prism film being transparent and placed on the top surface of the LGP.

10. The backlight module with uniform brightness as claimed in claim 8, wherein the backlight module with uniform brightness has a prism film being transparent and being placed on the top surface of the diffuser.

11. The backlight module with uniform brightness as claimed in claim 9, wherein the reflective film has a variable coverage density.

12. The backlight module with uniform brightness as claimed in claim 11, wherein the coverage density near the light source of the top surface of the reflective film is lower than the coverage density far from the light source.
